(19) United States
(12) Patent Application Publication
(10) Pub. No.: US 2017/0022007 A1
(43) Pub. Date: Jan. 26, 2017

(54) WEATHER PROTECTION APPARATUS, SYSTEM, AND METHOD

(71) Applicant: Osama El-Atari, Leesburg, VA (US)

(72) Inventor: Osama El-Atari, Leesburg, VA (US)

(21) Appl. No.: 14/804,414

(22) Filed: Jul. 21, 2015

(51) Int. Cl. B65F 1/14

(52) U.S. Cl. CPC B65F 1/1638; B65F 1/1646

(57) ABSTRACT

A cover is engaged in a track. The track surrounds a refuse container along a perimeter on at least three sides. The track is independent of the refuse container and not affixed to the refuse container. The cover is adapted to be expanded from one side of the track to expand and cover a top opening of the refuse container. The cover is also adapted to be retracted along the track when expanded back to the one side of the track to uncover and expose the top opening of the refuse container.

### BACKGROUND

Refuse containers that reside outdoors have been identified by the Environmental Protection Agency (EPA) as potential hazards to the environment because when it rains the refuse (which may or may not already be hazardous) can mix with the rain and seep out of the containers. This creates a situation where the contaminated mixture can seep into the ground or drain down storage drainage system and contaminate the ground, ground water, surrounding natural water supplies, and the like.

Most commercial dumpsters include a heavy plastic cover that remains shut until the garbage truck uses prongs to lift the dumpsters and dump the trash into the back of the truck for collection. When this occurs, the plastic cover opens due the angle and force of gravity and the garbage is dumped into the back of the truck. When the empty dumpster is reset on the ground by the truck prongs, the cover may or may not move back to a closed position to cover the top of the dumpster. When the cover does not close properly, the business associated with the dumpster relies on the garbage truck operator to manually close the dumpster with the plastic cover. There are a variety of issues associated with this process. First, the operator may not close the dumpster. Second the plastic covers become damaged after many collections due to the banging of the covers against the metal dumpster over time such that they do not provide good enough seals to block rain water from entering the dumpsters. Third, tenants of a business may open the covers to dispense a larger item of trash (such as a big box) and never re-shut the covers.

Additionally, some larger dumpsters (such as those available at construction sites) usually do not have large plastic covers that are made for the dumpsters because it is impractical and too expensive for such dumpsters. These types of dumpsters require large tarps to be placed over them during a rain event. Today, a business manually hires one or more individuals to tarp their construction-based dumpsters when rain is imminent at substantial fees or these business incur large environmental fines from the EPA when the dumpsters are detected as not being covered during a rain event.

Therefore, there is a need for improved weather protection for refuse containers.

### SUMMARY

In various embodiments, an apparatus, system, and method for weather protection of outdoor refuse containers are provided. According to an embodiment, an automated weather protection apparatus is taught.

Specifically, a weather protection apparatus includes a cover, a track, and an opening and closing mechanism. The cover is adapted to cover a top opening of a refuse container. The track is adapted to surround a perimeter along an outside of the refuse container on at least three sides of the refuse container. The opening and closing mechanism is adapted to expand the cover over the top opening along the track to a covered position. Moreover, the opening and closing mechanism is further adapted to retract the cover when in the covered position along the track to an uncovered position exposing the top opening of the refuse container.

### BRIEF DESCRIPTION OF THE DRAWINGS

FIG. 1A is a diagram of a weather protection apparatus and system in a covered position, according to an example embodiment.

FIG. 1B is a diagram of the weather protection apparatus and system of the FIG. 1A in an uncovered position, according to an example embodiment.

FIG. 2 is a diagram of a method for operating a weather protection apparatus, according to an example embodiment.

### DETAILED DESCRIPTION

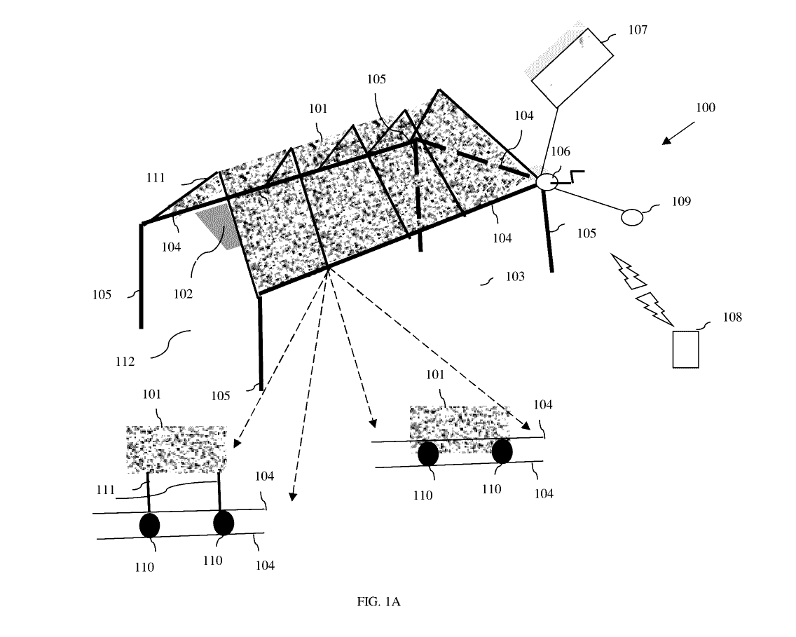

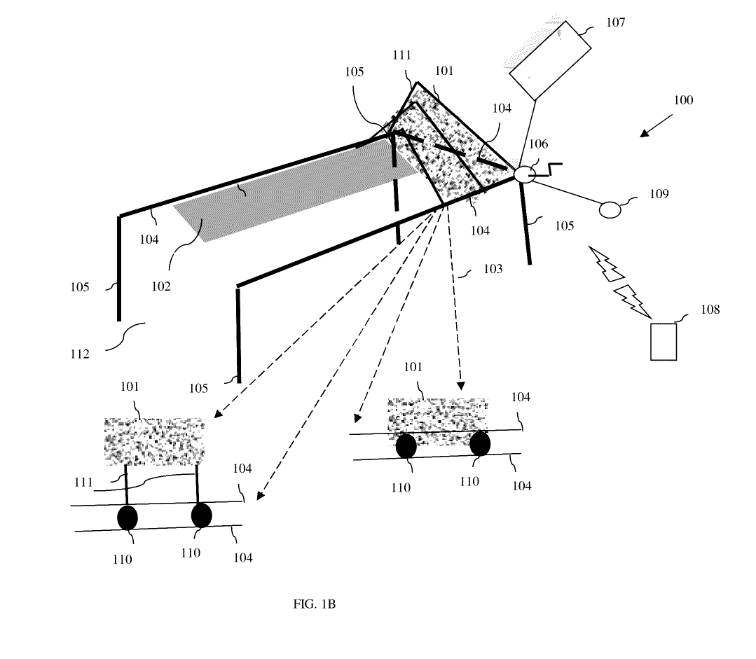

FIG. 1A is a diagram of a weather protection apparatus and system 100 in a covered position, according to an example embodiment. The components of the diagrams are shown in greatly simplified form with only those components shown necessary for the understanding various embodiments of the invention. Moreover, it is noted that the components of the apparatus and system 100 are not drawn to scale.

The apparatus 100 includes a cover 101, a track 104, and an opening and closing mechanism 106. The components 101, 104, and 106 represent a weather protection apparatus for a refuse container 103.

The system 100 includes the weather protection apparatus (101, 104, and 106) and the refuse container 103.

Various embodiments and arrangements of the weather protection apparatus and system 100 are not discussed with reference to the FIGS. 1A and 1B (the apparatus and system 100 of the FIG. 1A with the cover 101 shown in an uncovered position with a top opening 102 of the refuse container 103 exposed to the elements.

The cover 101 is adapted to completely cover the top opening 102 of the refuse container 103.

In an embodiment, the perimeter edges of the cover 101 include manufactured holes into which grommets are inserted to provide structure to the cover 101 and prevent tearing. Wheels 110 or a wheel assemblies 110 are bolted to the grommets permitting the wheels 110 to roll along the inside of the track 104, such that the cover 101 can be quickly and efficiently moved from an uncovered position (FIG. 1B) into a covered position (FIG. 1A).

In an embodiment, support poles or bars 111 are dispersed on an underside of the cover 101 to provide support to the cover 101 and to maintain the cover 101 in an elevated position above the top opening 102 of the refuse container 103. The elevated position can be in a vertical slant position (as shown in the FIG. 1A) or in a substantially horizontal position (not shown in the FIG. 1A) relative to the top opening 102.

In an embodiment, the cover 101 is a tarp manufactured as a 10 ounce tarpaulin that is 14′×25′ and affixed to the perimeter edges that affix to the track 104 through bows by grommets that are bolted. The bows are 60″ tall×120″ wide and connected to an 8″ base with 2″ wheels 110 that ride in a 2″ garage door channel track 104 that is 300″ long.

In an embodiment, poles or legs 111 are connected to the cover 101 on one end of the poles or legs 111 with the remaining ends of the poles or legs 111 connected to the wheels 110. This permits the cover 101 to be elevated above the track 104 at a height determined by the length of the poles or legs 111. According to an embodiment, the height of the poles or legs 111 is adjustable. In an embodiment, there are 6 poles or legs 111 affixed on one end to the cover 101 and on the other end to 2½″ lockable wheels 110.

The track 104 includes three sides that surround an outside perimeter of the refuse container 103. The track 104 is not in contact with and is not affixed to refuse container 103.

The track 104 is elevated above the surface (ground, concrete slab, elevated platform, and the like) upon which the refuse container 103 rests through posts or poles 105. The track 104 is affixed to the top of the posts or poles 105.

In an embodiment, the track 104 is elevated to a height that is slightly lower than a height of the refuse container 103.

In an embodiment, the track 104 is elevated to a height that is slightly higher that a height of the refuse container 103.

In an embodiment, the track 104 is elevated to a height that is substantially the same height of the refuse container 103.

In an embodiment, the track 104 is evaluated by four posts or poles 105.

In an embodiment, the track 104 includes one or more additional support posts or poles 105 for additional support while in the elevated position along an outside perimeter of the refuse container 103.

In an embodiment, the posts or poles 105 may include one or more additional support poles that are horizontally positioned below the track 104 and affixed to two vertically situated posts or poles 105.

In an embodiment, the posts or poles 105 are stabilized on the surface upon which the refuse container 103 rests by driving bottom portions of the posts or poles 105 into the surface (ground). In another case, the posts or poles 105 are stabilized on the surface through a bolting mechanism. In still another situation, the posts or poles 105 include a base having a manufactured hook or a hole to which a stake can be driven into the ground to stabilize each of the posts or poles 105. In another embodiment, the base is slightly enlarged and adapted to be filled with water, rocks, sand, or other heavy material to stabilize the posts or poles 105.

In an embodiment, the track 104 and the posts or poles 105 form an outline shape on three sides of the refuse container 103 having dimensions of 300″ long, 120″ wide, and 60″ tall.

In an embodiment, the refuse container 103 is a commercial dumpster.

The track 104 and poles or posts 105 are arranged such that there is at least one opening 112 on one side of the refuse container 103 to permit the refuse container 103 to be removed and emptied. For example, a truck can use existing automated mechanisms equipped to the truck to remove the refuse container 103 from within the weather protection apparatus (specifically the structure represented by 101, 104, and 105) and empty the refuse container 103. The truck can then replace the refuse container 103 back within the weather protection apparatus. Removal and emptying of the refuse container 103 occurs when the cover is in the uncovered position (FIG. 1B). Thus, usage, emptying, and replacing or resetting an existing the refuse container 103 can occur unimpeded with the teachings presented herein using the weather protection apparatus and environmental protection provided from weather elements during weather related events (rain, snow, hail, etc.).

The weather protection apparatus 100 also includes an opening and closing mechanism 106. The opening and closing mechanism 106 is adapted to urge the cover along the track 104 from an uncovered position (FIG. 1B) with the top opening 102 of the refuse container 103 exposed to the weather elements to a covered position (FIG. 1A) where the top opening 102 of the refuse container 103 is covered and shielded from the weather elements (rain, snow, hail, etc.).

In an embodiment, the opening and closing mechanism 106 is a hand crank that when cranked in a first circular direction (such as counter clockwise) moves the cover 101 from an uncovered position (FIG. 1B) to a covered position (FIG. 1A). Moreover, when the hand crank is cranked in a second circular direction (such as counter clockwise) the cover 101 is urged from a covered position (FIG. 1A) to an uncovered position (FIG. 1B). In an embodiment, the hand crank utilizes a system that includes a ⅛″ cable on 8″ pulleys with a 10″ crank handle.

In an embodiment, the opening and closing mechanism 106 includes a motor and a switch, such that when the switch is activated to a first setting the cover 101 is automatically (without manual effort) moved from an uncovered position (FIG. 1B) to a covered position (FIG. 1A). Moreover, when the switch is activated to a second setting the cover 101 is automatically moved from a covered position (FIG. 1A) to an uncovered position (FIG. 1B).

In an embodiment of the last embodiment, the motor is powered by a battery. In an embodiment, the battery is charged by one or more solar panels 107. In an embodiment, the switch is adapted to be controlled by a remote control mechanism 108. In an embodiment, the remote control mechanism 108 is a mobile device having a mobile device application implemented as executable instructions in a non-transitory computer-readable storage medium within the mobile device and executed by one or more processors of the mobile device. The mobile device application adapted to communicate with an application that executes on the opening and closing mechanism 106 (such as the switch having a processor configured for executing the application). Communication occurs wirelessly, such as through radio frequency (RF), Infrared (IR), cellular, WiFi, Blue Tooth®, and the like. The mobile application is adapted to acquire a status from the switch through the application executing on opening and closing mechanism 106. The status can include an indication as to whether the cover 101 is in a covered or uncovered position. Moreover, the mobile application is adapted to instruct the application executing on the opening and closing mechanism 106 to move the switch to remotely urge the cover 101 to a covered or uncovered position.

In an embodiment, the weather protection apparatus also includes a rain/snow or weather sensor 109 that is in communication with an application executing on the opening and closing mechanism 106 or in communication with the switch. Thus, the sensor 109 can urge the switch to the first position (causing the cover 101 to move to a closed position) and urge the switch to the second position (causing the cover 101 to move to an uncovered position). Still further, the application and/or switch can wait for a configurable period of time before activating the switch to the second position to ensure that weather related issues have really ceased.

In an embodiment, the weather protection apparatus may also include a light sensor, which uses a similar mechanism to that of the sensor 109 to cause the cover 101 to close when it is dark and open when it is light outside.

In some cases, a timer can be used as well to automatically cause the cover 101 to close and open at predefined times and for predefined periods during the day and/or during specific calendar days (such as holidays and weekends).

In an embodiment, the opening and closing mechanism 106 includes a hand crank and a motor (along with all the embodiments discussed with respect to the motor). This permits manual opening and closing of the cover 101 for whatever reason (such as motor failure, lack of motor power, etc.). In an embodiment, the opening and closing mechanism 106 includes all or some combination of: a hand crank, a motor, sensor 109, and remote control mechanism 108.

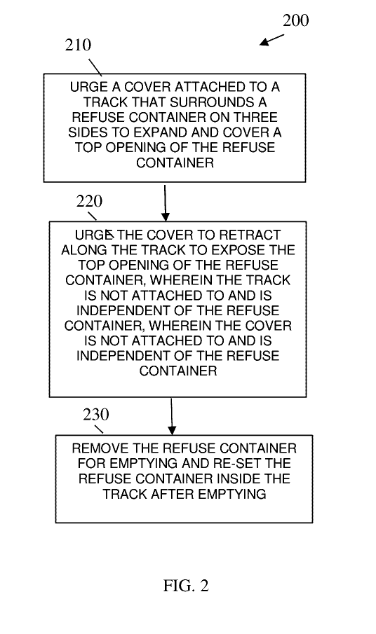

FIG. 2 is a diagram of a method 200 for operating a weather protection apparatus, according to an example embodiment.

In an embodiment, 210 and 220 of the method 200 are implemented as executable instructions within a non-transitory computer-readable storage medium and executed by one or more processes of an opening and closing mechanism for a weather protection system (as described above).

In an embodiment, the method 200 is operated by a hand crank.

At 210, a covered attached to a track that surrounds a refuse container on three sides is urged to expand and cover a top opening of the refuse container.

At 220, the cover is urged to retract along the track to expose the top opening of the refuse container.

The track is not attached to and is independent of the refuse container and the cover is independent of the refuse container.

One now appreciates how improved and automated environmental compliance and protection for refuse containers exposed to weather related elements can be achieved without changing the manner in which those refuse containers are used, emptied, and replaced at a site.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. An apparatus, comprising:
a cover adapted to cover a top opening of a refuse container;
a track adapted to surround a perimeter along an outside of the refuse container on at least three sides of the refuse container; and
an opening and closing mechanism adapted to expand the cover over the top opening along the track to a covered position, and wherein the opening and closing mechanism is further adapted to retract the cover when in the covered position along the track to an uncovered position exposing the top opening of the refuse container.

2. The apparatus of claim 1 further comprising a plurality of posts affixed to the cover at a first end and affixed to wheels on a second end, wherein the wheels engage in the track to move the cover to and from the covered position and the uncovered position.

3. The apparatus of claim 2, wherein the posts when affixed to the first end of the cover and affixed to the wheels on the second end with the wheels engaged in the track elevate the cover above the top opening when the cover is in the covered position.

4. The apparatus of claim 3, wherein the cover when in the covered position extends beyond a length and a width of the top opening of the refuse container.

5. The apparatus of claim 1 further comprising at least four posts adapted to elevate the track above a surface upon which the refuse container is placed along the at least three sides of the perimeter of the refuse container.

6. The apparatus of claim 5, wherein the track and the at least four posts are spaced equidistant along the perimeter of refuse container on the at least three sides and represent an independent structure that is not attached or affixed to the refuse container.

7. The apparatus of claim 6, wherein the track and the at least four posts are arranged to include an opening on one side of the refuse container to permit the refuse container to be removed and emptied.

8. The apparatus of claim 1, wherein the opening and closing mechanism includes a hand crank, the hand crank adapted to be cranked in a first direction to move the cover into the covered position and the hand crank adapted to be cranked in a second direction to move the cover into the uncovered position.

9. The apparatus of claim 1, wherein the opening and closing mechanism includes a motor and a switch, and when the switch is activated to a first setting the cover is moved to the covered position and when the switch is activated to a second setting the cover is moved to the uncovered position.

10. The apparatus of claim 9, wherein the motor is powered by a battery.

11. The apparatus of claim 10, wherein the battery is charged by one or more solar panels.

12. The apparatus of claim 9, wherein the switch is adapted to be controlled wirelessly by a remote control mechanism.

13. The apparatus of claim 12, wherein the remote control mechanism is a mobile device application adapted to execute on a mobile device that connects to an application adapted to execute on a processor associated with the switch to receive a status on whether the cover is in the covered position or the uncovered position and the mobile application adapted to communicate wirelessly with the application of the switch to move the cover to the covered position or the uncovered position.

14. The apparatus of claim 12 further comprising a rain/snow sensor adapted to detect when it is raining/snowing and activate the switch to the first position, and the rain/snow sensor further adapted to detect when rain/snow has stopped for a configurable period of time and activate the switch to the second position.

15. A system, comprising:
a refuse container; and
a weather protection apparatus;
wherein the weather protection apparatus is adapted to move a cover to a covered position that covers a top opening of the refuse container and adapted to retract the cover from the covered position to an uncovered position, and wherein the weather protection apparatus is not affixed to the refuse container and the weather protection apparatus is further adapted to permit the refuse container to be removed from the weather protection apparatus for emptying and returned within the weather protection apparatus after emptying.

16. The system of claim 15, wherein the weather protection apparatus is adapted to be remote controlled to move the cover to the covered position and the uncovered position.

17. The system of claim 15, wherein the weather protection apparatus is adapted to be hand cranked to move the cover to the covered position and the uncovered position.

18. The system of claim 15, wherein weather protection apparatus is adapted to detect when it is raining/snowing and move the cover to the closed position, and wherein the weather protection apparatus is further adapted to detect when rain/snow has stopped for a configurable period of time retract the cover to the uncovered position.

19. A method of claim, comprising:
urging a cover attached to a track that surrounds a refuse container on three sides to expand and cover a top opening of the refuse container; and
urging the cover to retract along the track to expose the top opening of the refuse container, wherein the track is not attached to and is independent of the refuse container, and wherein the cover is not attached to and is independent of the refuse container.

20. The method of claim 19 further comprising, removing the refuse container for emptying and re-setting the refuse container inside the track after emptying.
